(19) United States
(12) Patent Application Publication
(10) Pub. No.: US 2003/0140139 A1
(43) Pub. Date: Jul. 24, 2003

(54) Self-monitoring and trending service system with a cascaded pipeline with a unique data storage and retrieval structures

(76) Inventors: Richard Marejka, Nobleton (CA); Guy Birkbeck, Scarborough (CA); Louis Ferrante, Nobleton (CA); Dariusz Dabrowski, Toronto (CA)

Correspondence Address: HOGAN & HARTSON LLP, ONE TABOR CENTER, SUITE 1500, 1200 SEVENTEEN ST., DENVER, CO, 80202, US

(21) Appl. No.: 10/184,605

(22) Filed: Jun. 27, 2002

Related U.S. Application Data
(60) Provisional application No. 60/348,328, filed on Jan. 14, 2002.
(60) Provisional application No. 60/377,125, filed on Apr. 30, 2002.

(51) Int. Cl. G06F 15/173

(52) U.S. Cl. 709/224

(57) ABSTRACT

A database structure, system and method as part of a self-monitoring system that provides a scalable solution to delivering self-service solutions including system monitoring, trend reporting, asset tracking, and asset time delta reporting. The database structure is represented by Entity Relationship Diagrams (ERDs) that illustrate how tables and columns of data are interrelated. The database is organized to store and retrieve data from customer systems on a customer network, including data about the configuration of the customer systems and customer network and trends occurring on the customer systems and network. The configuration and trend data stored in the database can be processed by service provider system and displayed as custom tailored reports to operators of the customer network through customer management nodes.

### CROSS-REFERENCE TO RELATED APPLICATIONS

This application claims the benefit of U.S. Provisional Application No. 60/348,328 entitled “Self-Monitoring and Trending Service System with A Cascaded Pipeline with a Unique Data Storage and Retrieval Structures,” filed Jan. 14, 2002, and U.S. Provisional Application No. 60/377,125 entitled “Self-Monitoring and Trending Service System with A Cascaded Pipeline with a Unique Data Storage and Retrieval Structures,” filed Apr. 30, 2002, the disclosure of which is herein specifically incorporated in its entirety by this reference.

### BACKGROUND OF THE INVENTION

1. Field of the Invention

The present invention relates, in general, to databases used with software and systems for monitoring, reporting, and asset tracking, and more particularly, to databases used with methods and systems for controlling communication and service distribution in a network of client and service provider devices that utilizes a cascaded pipeline with a plurality of relays to provide a reliable store and forward mechanism with priority messaging.

2. Relevant Background

The need for effective and cost efficient monitoring and control of servers and their clients and computer network components, i.e., systems management, continues to grow at a rapid pace in all areas of commerce. There are many reasons system management solutions are adopted by companies including reducing customer and service downtime to improve customer service and staff and customer productivity, reducing computer and network costs, and reducing operating expenditures (including reducing support and maintenance staff needs). A recent computer industry study found that the average cost per hour of system downtime for companies was $90,000 with each company experiencing 9 or more hours of mission-critical system downtime per year. For these and other reasons, the market for system monitoring and management tools has increased dramatically and with this increased demand has come pressure for more effective and user-friendly tools and features.

There are a number of problems and limitations associated with existing system monitoring and management tools. Generally, these tools require that software and agents be resident on the monitored systems and network devices to collect configuration and operating data and to control communications among the monitored devices, control and monitoring consoles, and a central, remote service provider. Data collected on the monitored systems is displayed on the monitoring console or client node with tools providing alerts via visual displays, emails, and page messages upon the detection of an operating problem. While providing useful information to a client operator (e.g., self-monitoring by client personnel), these tools often require a relatively large amount of system memory and operating time (e.g., 1 to 2 percent of system or device processing time).

The use of system memory and operating time on the monitored system becomes an even greater issue when network managers use the system to process the raw monitoring data into important trending data that show trends in the status of the system and help forecast future network needs. As the network grows, demands on the memory and processing time required to collect and process the monitoring data can rapidly increase.

Additionally, in many monitored networks and systems, intermediate or forwarding relays are provided between a monitoring service provider system and the monitored systems for transferring messages and data between the server and monitored systems. Presently, the forwarding relays are configured with memory and software to support a relatively small number of monitored systems, i.e., the ratio of monitored systems to relays is kept relatively small. With this arrangement, it is difficult to later add new monitored systems without modifying the hardware and/or software of the relays or without adding additional relays. Moreover, the volume of data and messages sent between monitored systems and the service provider server can vary significantly over time leading to congestion within the network and the delay or loss of important monitoring and control information.

In light of these scalability issues, there remains a need for an improved system and method for monitoring computer systems and networks of increasing size and complexity. Such a system and method would be “light” on the end user's system requiring less memory and/or processing time to provide desired monitoring, control, and trending features. Additionally, the system and method should also provide efficient and reliable ways to transfer and process data between the monitored systems and networks and a central service provider system or server.

### SUMMARY OF THE INVENTION

One object of the present invention is a database for a remote computer system monitoring service that comprises a plurality of configuration data structures, wherein each of said plurality of configuration data structures is associated with a monitored computer system, and wherein each of said configuration data structures comprises a searchable configuration attribute that includes information about the monitored computer system.

Another object of the present invention is a method of displaying a message from a self-monitoring system, comprising the steps of storing data from the self-monitoring system in a database; processing the data from the database to generate the message; and displaying the message at customer management node, wherein the database comprises an identity entity that uniquely identifies a customer system in electronic communication with the self-monitoring system; and at least one data entity for data from the self-monitoring system.

Another object of the present invention is a self-monitoring system for providing self-service tools from a service provider system linked through a communications network to a customer network, comprising a communication pipeline within a customer network adapted for digital data transfer; a plurality of monitored relays linked to the pipeline comprising end nodes running at least a portion of the provided self-service tools; a forwarding relay linked to the pipeline upstream of the monitored relays adapted to control flow of data transmitted between the service provider system and the monitored relays, wherein the forwarding relay includes means for storing the transmitted data and selectively forwarding the stored data on the pipeline; a customer relay linked to the pipeline and to the communications network providing a communication interface between the service provider system and the forwarding relay; and a data structure stored in memory of the system including data resident in a database used by the service provider system in providing the self-service tool, wherein the data in the database includes data collected at the monitored relays and transmitted over the communication pipeline.

Still another object of the present invention is a database for a remote computer system monitoring service, the database comprising a plurality of configuration data structures, wherein each configuration data structure is associated with a particular monitored computer system; and a system delta data structure, wherein the system delta data structure is associated with at least one of the plurality of configuration data structures, and includes information on a configuration change associated with said at least one configuration data structure.

Yet another object of the present invention is a database for a remote computer system monitoring service, the database comprising: a plurality of configuration data structures, wherein each configuration data structure is associated with a particular monitored computer system; and a RAS system analysis data structure, wherein the RAS system analysis data structure is associated with at least one of the plurality of configuration data structures.

The database of the present invention is preferably in electronic communication with the service provider system portion of the self-monitoring system. The service provider system is in electronic communication with one or more customer systems via a cascaded pipeline architecture. The cascaded pipeline architecture is particularly suited for scaling from a relatively small number of client or customer systems or environments up to a network having 10,000 or more systems and allows a single service provider system or other solution provider to effectively distribute solutions, applications, messages, and the like to all the customer systems on the network.

The database itself is preferably a relational database for the storage and retrieval of data that is collected and processed by a self-monitoring system. The data preferably include configuration data that catalog some or all of the hardware and software in customer systems, and trending data that describe the behavior of one or more aspects of the customer network over a period of time.

In another aspect of the present invention, the database stores data that is used in a variety of customer network monitoring functions. These functions preferably include generating alarms when an aspect of the customer network exceeds a predefined threshold value; generating trend reports based on the trending data stored on the database; and generating configuration and patches reports that list information about one or more pieces of hardware or software on the customer network.

These and other features and advantages of the invention, as well as the structure and operations of various embodiments of the invention, are described in detail below with reference to the accompanying figures.

### BRIEF DESCRIPTION OF THE DRAWINGS

FIG. 1 illustrates generally self-monitoring system in which the database of the present invention may be implemented;

FIG. 2 illustrates generally an Entity Relationship Diagram for modeling a configuration portion of the database;

FIG. 3 illustrates generally an Entity Relationship Diagram for modeling a treading portion of the database;

FIG. 4 illustrates a self-monitoring system according to the present invention generally showing the use of forwarding or fan-out relays to provide scalability to link a service provider system and its services to a large number of monitored systems or relays;

FIG. 5 illustrates an embodiment of the self-monitoring system of FIG. 4 showing in more detail components provided within the service provider system the forwarding relay, and the monitored system or relay to provide the desired reliable and prioritized data transfer within such a service system;

FIG. 6 shows an example database of the present invention that includes System Delta data structures; and

FIG. 7 shows an example database of the present invention that includes RAS System Analysis data structures.

### DETAILED DESCRIPTION OF THE PREFERRED EMBODIMENTS

While the invention is susceptible to various modifications and alternative forms, specific embodiments thereof are shown by way of example in the drawings above, and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### Example of Hardware Configuration

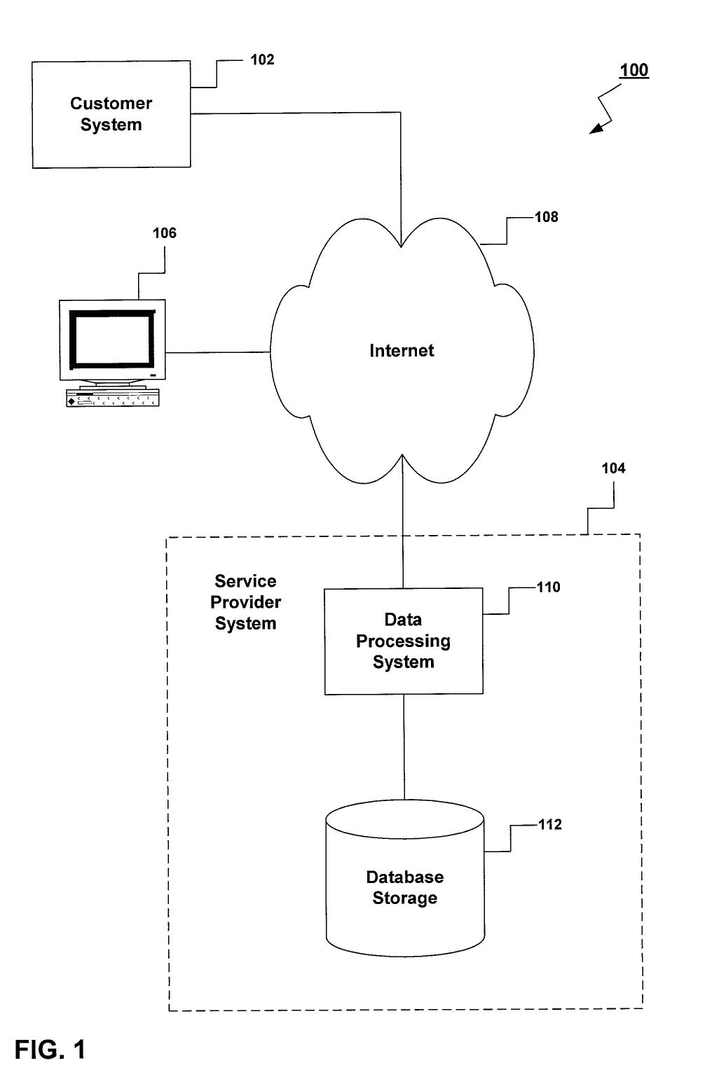

With reference now to FIG. 1, a simplified hardware configuration 100 physically implementing the database of the present invention is depicted. The hardware configuration 100 includes a customer system 102, a service provider system 104, and a customer management system 106, all in electronic communication with the Internet 108. Configuration and trending data generated by the customer system 102 is sent via the Internet to the service provider system 104 that is preferably situated in a separate location. A more detailed description of how data is generated and transferred in the self-monitoring system via a cascaded pipeline can be found below in the Overview of the Self-Monitoring System.

The service provider system 104 preferably comprises a data processing system 110 in electronic communication with a data storage system 112. The data processing system 110 preferably comprises one or more computers. For example, the data processing system 110 may comprise at least two computers with multiple central processing units that constitute a cluster. Database Management Systems (DBMS) are implemented on the data processing system 110 to process, store and retrieve data in the data storage system 112. The DBMS is preferably a Relational Database Management System (RDBMS). The RDBMS is preferably implemented in RDBMS software including software using DB2, Oracle, Informix, or Sybase DBMS solutions. The RDBMS software may run on a number of operating systems, including IBM OS/2, IBM OS/390, Microsoft Windows, Linux, IBM-AIX, Hewlett-Packard HP-UX, Sun Solaris, among others.

The data storage system 112 comprises a physical storage medium, such as a hard disk drive, a tape drive, non-volatile memory, or combinations of these types of data storage. The data storage system 112 preferably employs hard disk drive technology such as a single hard drive, a virtual hard disk drive made up of portions of two or more physical hard disk drives, a storage area network (SAN) system, or a network attached storage (NAS) system, among others. The data storage system 112 may be located within or external to the data processing system 110.

### Conceptual Model of the Database

The conceptual model of the database of the present invention is preferably resolved into a model for the trending data and a model for the configuration data. The model for the configuration data is preferably further resolved into a model for the hardware configuration and a model for the software configuration of the one or more customer systems on the customer network.

In the models for both trending and configuration data, there is an entity for uniquely identifying each customer system on the customer network. This customer system identity entity comprises one or more attributes, including customer system (a.k.a. “client”) identifying data, relay identifying data, node identifying data, domain identifying data, operating system identifying data, client location data, client timezone data, security certificate data. Attributes can also include a history of events that have occurred on a customer system, such as its alarm history, reboot history, threshold event history, upgrade history, and start date on the customer network. In a preferred aspect, a unique customer system number assigned by the service provider system is used to uniquely identify each customer system on a customer network. The unique customer system number may be the sole attribute of the customer system identity entity, or it may be used in conjunction with additional attributes to identify a particular customer system.

The models for both trending and configuration data also preferably incorporate entities that identify reports that are generated and sent to the customer by the self-monitoring system. Report identity entities have attributes that preferably include the data and time the report is generated, the date and time a previous report was generated, and a sequential report number.

The reports are preferably generated on a periodic basis where the period can be lengthened or shortened depending on a customer's wishes. The reports themselves describe customer system configurations and operational trends of the customer network. The reports are preferably customized by each customer to show configuration and trending data for the entire customer network, or a subset of the network upon which the customer wishes to focus. For example, a customer with a worldwide customer network may customize a report focus on customer systems located in North America, Europe or Asia. The reports can be customized to focus on groups of customer systems that share any number of characteristics, including any of the attributes of the customer system identity entity described above.

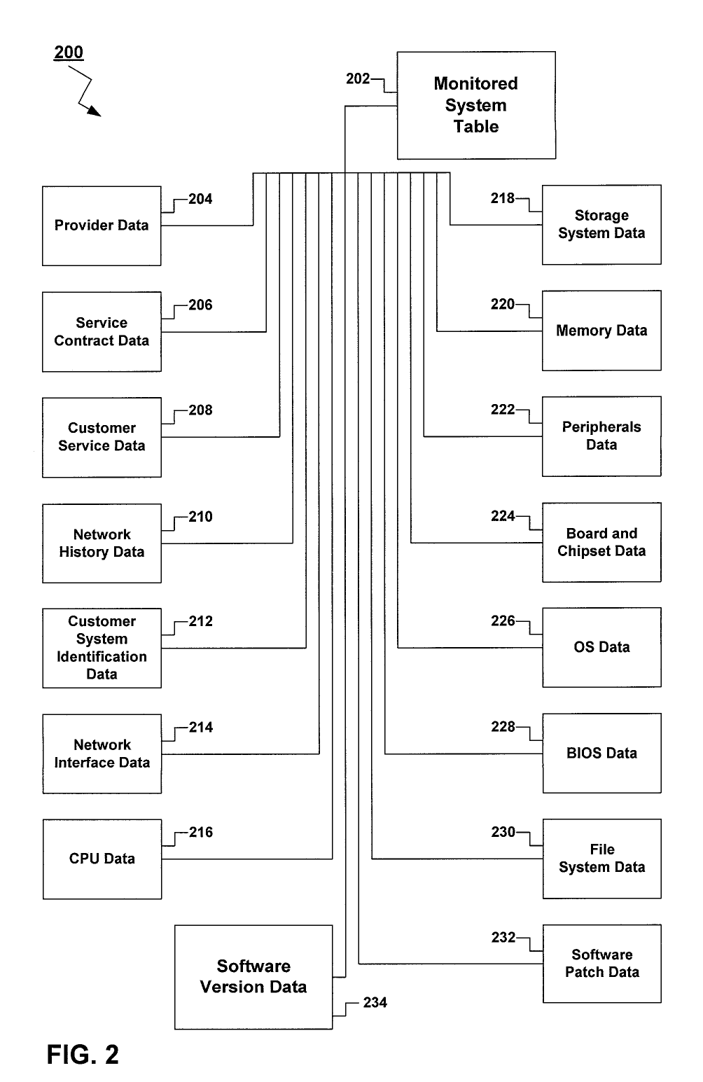

Referring now to FIG. 2, an Entity Relationship Diagram (ERD) 200 for the collection and processing of configuration data is shown. The ERDs shown here use Integration DEFinition (IDEF1X) notation to represent the entities, attributes and relationships as tables, columns in tables and lines. The monitored system table 202 represents each customer system on a customer network. Table 202 groups one or more attributes of customer systems, represented as columns. The columns group data about the customer network according a characteristic of the customer systems. For example, a column can represent customer system (a.k.a. “client”) identifying data, relay identifying data, node identifying data, domain identifying data, operating system identifying data, client location data, client timezone data, security certificate data, alarm history data, reboot history data, threshold event history data, upgrade history data, and data on when a customer system started on the customer network, among other customer system characteristics. In a preferred aspect, a primary key of the monitored system table 202 includes a unique customer system identification number generated and assigned by the service provider system.

Configuration data received from the customer systems can be disaggregated in a variety of ways. In the example ERD 200 shown in FIG. 2, there are tables for provider data 204; service contract data 206; customer system 208 and network history data 210; customer system identification data 212; network interface data 214, including IP address data, Machine Address Code (MAC) data, Netmask data, and broadcast data; hardware data, including CPU data 216, storage system data 218, memory data 220, peripherals data 222, board and chipset data 224, and network system data; and software data, including operating system data 226, BIOS data 228, file system data 230, software patch data 232, system module data, installed package data, software version data 234 and swap information data.

For each of these tables, one or more attributes are represented as columns in the tables. For example, storage system data 218 can be disaggregated such that data for hard disk drive systems is stored on a hard disk drive systems table. The hard disk drives systems table preferably comprises a number of columns that represent attributes of hard disk drive systems, including physical disk bytes per sector, sectors per track, tracks per cylinder, sectors per cylinder, number of cylinders, number of accessible cylinders, vendor, product, serial number, storage size, rotation speed, and bus connection type among other attributes of a hard disk drive system.

In a preferred aspect, the conceptual model of the database 200 includes tables for software patch data 232, such as tables that identify patches which have been installed on a customer system. The obsolete and/or incompatible software patches data is arrived at by a comparison of “Software Patch Data” 232 and a Master Patch Table that is part of table 112. The obsolete and/or incompatible patch report can be viewed as a report by the customer at a customer management node. Additional tables are preferably part of the database structure for data on alarm and information about the report generated by the alarm.

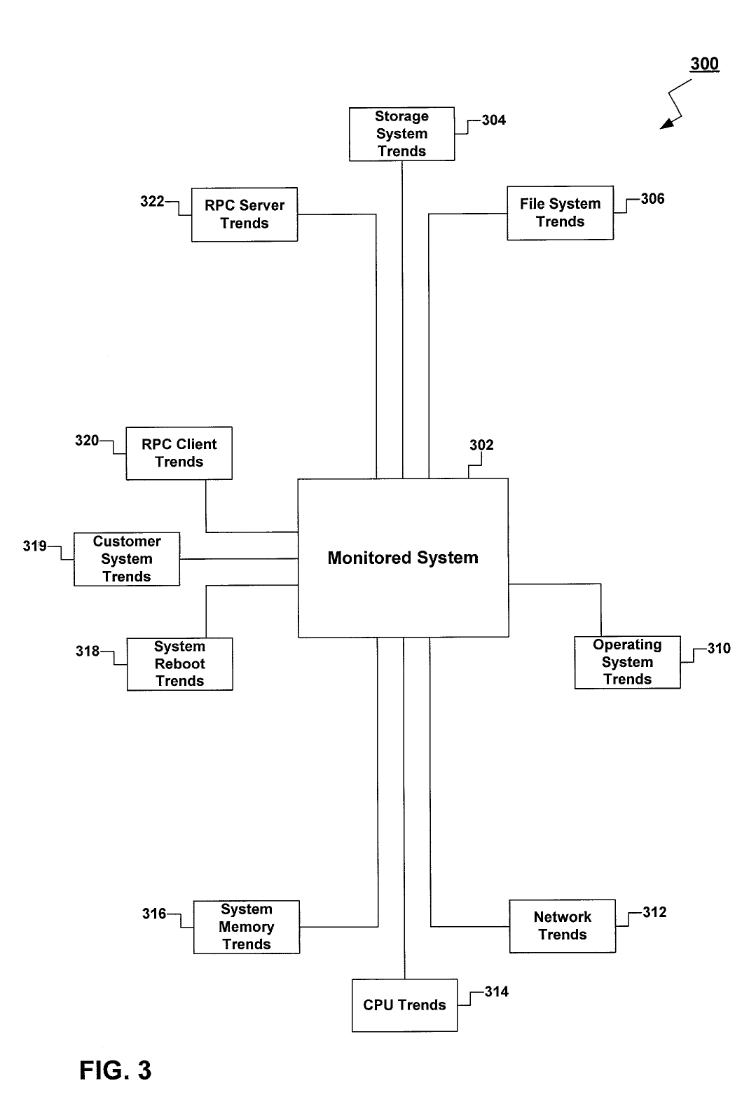

Referring now to FIG. 3, an Entity Relationship Diagram (ERD) 300 for the collection and processing of trending data is shown. The trending data can be disaggregated in a variety of ways. In the example ERD 300 shown in FIG. 3, there are tables for storage system trends 304, file system trends 306, operating system trends 310, network trends 312, CPU trends 314, system memory trends 316, customer system trends 319, system rebooting trends 318, and rpc client 320 and server trends among others 322.

The trending data tables also include one or more attributes that are implemented as columns in the tables. For example, columns for a system storage trend table 304 include the number of read and write commands executed on hard disk drive, the total number of bytes read/written, the time required to execute those commands, the average service time and the average wait time. Columns for a file systems trends table 306 include the percentage of the filesystem used and the total block count for the file system. Columns for a network trends table 312 include the percentage of packets that collide on the network, the percentage of packets that get deferred, the percentage erroneous packets, and the bandwidth utilization on the network. Columns for a CPU trends table 314 include percentage of a CPU used by the system kernel, the percentage of CPU used by the system user, and percentage the CPU spends waiting. Columns for customer system trends table 319 include the percentage of CPU utilization, the run queue, the load average, the memory utilization, the swap space utilization, the number of blocks that are read and written to storage, and the percentage of read and write hits. Columns for the rpc client trends table 320 include the numbers of times new credentials is sent to a server system in response to an authentication failure, retransfers, bad calls, calls, timeouts, bad verifications, bad sends, bad connects, and interrupts. Columns for the rpc server trends tables 322 include the number of duplicate checks, client to server RPC calls containing an invalid length of arguments error, duplicate requests, bad calls, nulls received, calls and xdr calls.

The conceptual model illustrated in the figures above can be implemented in a number of ways, including as a relational database, a hierarchical database, a multidimensional database, and a network database among others. In the aspect shown, the database is modeled as a relational database that is implemented on the self-monitoring system using a Relational DataBase Management System (RDBMS). The RDBMS software described here is not limited to any particular program supported by any particular operating system. For example, the RDBMS software may include DB2, Oracle, Informix, Sybase or other RDBMS software, and can run on computers using operating systems such as IBM OS/2, IBM OS/390, Microsoft Windows, Linux, IBM-AIX, Hewlett-Packard HP-UX, Sun Solaris, and other operating systems.

It should also be noted that the conceptual model of the database of the present invention does not have rigid distinctions between entities and attributes. An entity (represented by a table) in one part of the conceptual model may be an attribute (represented as a column) in another part. The choices of entities and attributes in the examples above do not limit the scope of the invention only to database structures that use the same entities and attributes.

It should also be recognized that there are a variety of ways to group attributes under a particular entity, and that the groupings illustrated here are but some of the many groupings contemplated by the invention. For example, in the description of the table for operating system trends, several of the columns could be placed under a customer system trends table. Furthermore, two or more entities or attributes represented by tables and columns may be concatenated into a single table or column.

### Overview of the Self-Monitoring System

The present invention includes a database that is used with a self-monitoring system. The self-monitored system utilizes a cascaded pipeline architecture including linked monitored relays, forwarding relays, and Internet relays. The cascaded pipeline architecture is particularly suited for scaling from a relatively small number of client or customer systems or environments up to a network having 10,000 or more systems in a customer environment to allow a single service or solution provider to effectively distribute solutions, applications, messages, and the like to the networked systems.

In the self-monitored system, the monitored relays are end node systems connected to the pipeline. The forwarding relays are linked to the pipeline and positioned downstream of the monitored relays and configured to support 1 to 500 or more end node systems or monitored relays (e.g., providing a monitored system to relay ratio of 500 to 1 or larger) by functioning to forward and fan out the delivery of self-monitoring and other tools to customers. The Internet relays are positioned downstream of the forwarding relays and are the final point within the customer environment or network. The Internet relays function to send messages and data to the service provider system. The pipeline of the service system is adapted to be a reliable store and forward mechanism with priority-based messaging. For example, in one embodiment, a message of higher priority is sent through the pipeline during the transmission of a lower priority message. In this example, the lower priority message is typically temporarily suspended and transmission is resumed when messages with a higher priority level are no longer pending in the reliable message store.

The self-monitoring system supports methods of controlling data transmission within a self-monitoring system, and particularly within the customer's system and/or network, utilizing priority-based messaging. The method includes receiving messages with an assigned priority at a forwarding relay. Each of the received messages is examined for priority and inserted based on its assigned priority into a relay message store 542 having a FIFO queue for each message priority. Typically, a file of a number of messages of a single priority is assembled and then the file is placed in the FIFO, priority-based queue. The method continues with determining the present highest priority message within the relay message store 542 and then transmitting this message from the forwarding relay to the appropriate recipient (such as an upstream monitored system or a downstream service provider system or relay). The method then involves a next determination of the existing highest priority message in the temporary storage and retrieving and sending the next message in the FIFO queue that has that priority. Portions (i.e., messages) of a file having a lower priority may be sent until a higher priority message is received and placed in the relay message store 542. At this point, the file's transmittal is interrupted for transmittal of a higher priority file and its messages and then transmittal of the lower priority is resumed once the higher priority message(s) are sent (unless additional higher priority message have been received). Messages for transmittal upstream and downstream of the forwarding relay are received at least partially concurrently and a reliable message storage having priority queues as provided for each set of received messages. Further, transmittal of messages upstream and downstream based on priority is occurring substantially concurrently.

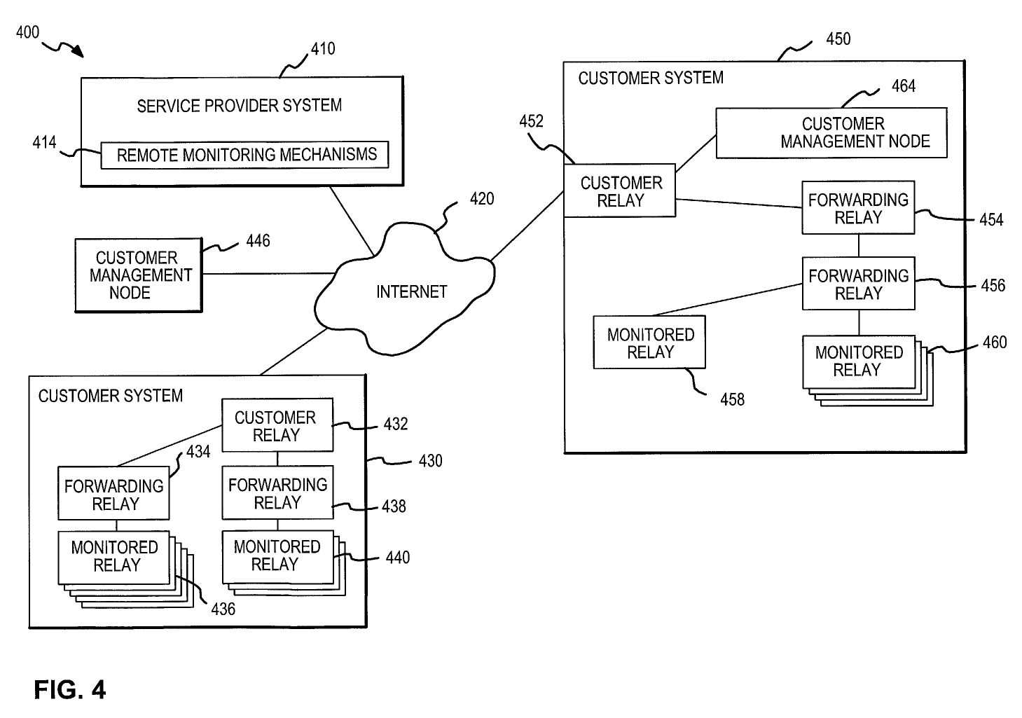

Referring to FIG. 4, a self-monitoring system 400 is shown that provides a scalable solution to delivering self-service solutions such as system monitoring, trend reporting, and asset tracking. The system 400 includes a service provider system 410 with remote monitoring mechanisms 414 that function to process collected data and provide event, alert, trending, status, and other relevant monitoring data in a useable form to monitoring personnel, such as via customer management nodes 446, 464. The service provider system 410 is linked to customer systems or sites 430, 450 by the Internet 420 (or any useful combination of wired or wireless digital data communication networks). The communication protocols utilized in the system 400 may vary to practice the invention and may include for example TCP/IP and SNMP. The service provider system 410 and customer systems 430, 450 (including the relays) may comprise any well-known computer and networking devices such as servers, data storage devices, routers, hubs, switches, and the like. The described features of the invention are not limited to a particular hardware configuration.

The self-monitoring system 400 is adapted to provide effect data transmissions within the customer systems 430, 450 and between the service provider system 410 and the customer systems 430, 450. In this regard, the system 400 includes a cascaded pipeline architecture that includes within the customer systems 430, 450 linked customer or Internet relays 432, 452, forwarding (or intermediate or fan-out) relays 434, 438, 454, 456, and monitored relays 436, 440, 458, 460. The monitored relays 436, 440, 458, 460 are end nodes or systems being monitored in the system 400 (e.g., at which configuration, operating, status, and other data is collected). The forwarding relays 434, 438, 454, 456 are linked to the monitored relays 436, 440, 458, 460 and configured to support (or fan-out) monitored systems to forwarding relay ratios of 500 to 1 or larger. In one embodiment, the pipeline is adapted to control the transmission of data or messages within the system and the forwarding relays act to store and forward received messages (from upstream and downstream portions of the pipeline) based on priorities assigned to the messages. The customer relays 432, 452 are positioned between the Internet 420 and the forwarding relays 434, 438, 454, 456 and function as an interface between the customer system 430, 450 (and, in some cases, a customer firewall) and the Internet 420 and control communication with the service provider system 410.

The system 400 of FIG. 4 is useful for illustrating that multiple forwarding relays 434, 438 may be connected to a single customer relay 432 and that a single forwarding relay 434 can support a large number of monitored relays 436 (i.e., a large monitored system to forwarding relay ratio). Additionally, forwarding relays 454, 456 may be linked to provide more complex configurations and to allow even more monitored systems to be supported within a customer system 430, 450. Customer management nodes 446, 464 used for displaying and, thus, monitoring collected and processed system data may be located anywhere within the system 400 such as within a customer system 450 as node 464 is or directly linked to the Internet 420 and located at a remote location as is node 446. In a typical system 400, more customer systems 430, 450 would be supported by a single service provider system 410 and within each customer system 430, 450 many more monitored relays or systems and forwarding relays would be provided, with FIG. 4 being simplified for clarity and brevity of description.

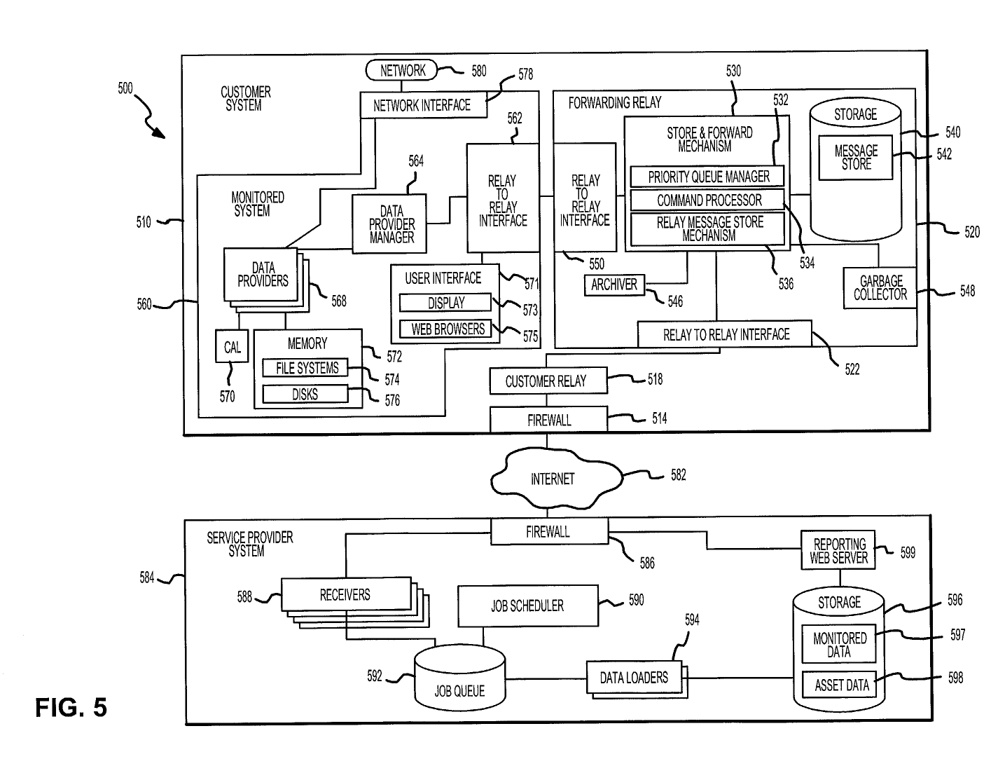

FIG. 5 shows a remote monitoring service system 500 that includes a single customer system 510 linked to a service provider system 584 via the Internet 582. FIG. 5 is useful for showing more of the components within the monitored system or relay 560, the forwarding relay 520, and the service provider system 584 that function separately and in combination to provide the high monitoring system to relay ratios and the unique store and forward messaging of the present invention. As shown, the customer system 510 has a user interface 574 that includes a display 573 and web browser 575. The customer system 510 also includes a firewall 514 connected to the Internet 582 and a customer relay 518 providing an interface to the firewall 514 and controlling communications with the service provider system 584.

According to an important aspect of the invention, the customer system 510 includes a forwarding relay 520 linked to the customer relay 518 and a monitored system 560. The forwarding relay 520 provides a number of key functions including accepting data from upstream sources and reliably and securely delivering it downstream. Throughout the following discussion, the monitored system 560 will be considered the most upstream point and the service provider system 584 the most downstream point with data (i.e., “messages”) flowing downstream from the monitored system 560 to the service provider system 584. The forwarding relay 520 accepts data from upstream and downstream sources and reliably and securely delivers it downstream and upstream, respectively. The relay 520 caches file images and supports a recipient list model for upstream (fan-out) propagation of such files. The relay 520 manages the registration of new monitored systems and manages retransmission of data to those new systems. Importantly, the forwarding relay 520 implements a priority scheme to facilitate efficient flow of data within the system 500. Preferably, each forwarding relay 520 within a service system has a similar internal structure.

The forwarding relay 520 includes two relay-to-relay interfaces 522, 550 for receiving and transmitting messages to connected relays 518, 560. A store and forward mechanism 530 is included for processing messages received from upstream and downstream relays and for building and transmitting messages. This may be thought of as a store and forward function that is preferably provided within each relay of the system 500 (and system 100 of FIG. 1) and in some embodiments, such message building and transmittal is priority based. To provide this functionality, the store and forward mechanism 530 includes a priority queue manager 532, a command processor 534, and a reliable message store mechanism 536 and is linked to storage 540 including a message store 542.

The priority queue manager 532 is responsible for maintaining a date-of-arrival ordered list of commands and messages from upstream and downstream relays. The command processor 534 coordinates overall operations of the forwarding relay 520 by interpreting all command (internal) priority messages and also acts as the file cache manager, delayed transmission queue manager, and relay registry agent. The reliable message store mechanism 536 acts to process received message and commands and works in conjunction with the priority queue manager 532 to build messages from data in the message store 542 and to control transmission of these built messages. The mechanism 536 functions to guarantee the safety of messages as they are transmitted within the system 500 by creating images of the messages in storage 540 (e.g., on-disk images) and implementing a commit/destroy protocol to manage the on-disk images. In general, a “message” represents a single unit of work that is passed between co-operating processes within the system 500. The priority queue manager 532 functions to generate priority queues. This allows the relay 520 to obtain a date-ordered set of priority queues directly from the mechanism 530.

Generally, the message store 542 stores all messages or data received from upstream and downstream sources while it is being processed for transmittal as a new message. The store 542 may take a number of forms. In one embodiment, the store 542 utilizes a UNIX file system to store message images in a hierarchical structure (such as based on a monitored system or message source identifier and a message priority). The priority queue manager 532 implements a doubly-linked list of elements and allows insertion to both the head and tail of the list with searching being done sequentially from the head of the queue to the tail. Messages are typically not stored in the priority queue manager 532 but instead message descriptors are used to indicate the presence of messages in the message store 542. The priority queue manager 532 may create a number of queues such as a queue for each priority level and extra queues for held messages which are stored awaiting proper registration of receiving relays and the like. A garbage collector 548 is provided to maintain the condition of the reliable message store 542 which involves removing messages or moving messages into an archival area (not shown) with the archiver 546 based on expiry policy of the relay 520 or system 500.

In some embodiments, the forwarding relay 520 with the store and forward mechanism 530 functions to send information based upon the priority assigned (e.g., by the transmitting device such as the monitored system 560 or service provider system 584) to the message. Priorities can be assigned or adjusted based on the system of origination, the function or classification of the message, and other criteria. For example, system internal messages may be assigned the highest priority and sent immediately (e.g., never delayed or within a set time period, such as 5 minutes of posting). Alerts may be set to have the next highest priority relative to the internal messages and sent immediately or within a set time period (barring network and Internet latencies) such as 5 minutes. Nominal trend data is typically smaller in volume and given the next highest priority level. High-volume collected data such as configuration data is given lowest priority. Of course, the particular priorities assigned for messages within the system 500 may be varied to practice the prioritization features of the present invention.

The monitored system 560 typically includes components to be monitored such as one or more CPUs 570, memory 572 having file systems 574 (such as storage area networks (SANs), file server systems, and the like) and disk systems 576, and a network interface 578 linked to a customer or public network 580 (such as a WAN, LAN, or other communication network). A user interface 565 is included to allow monitoring of the monitored system 560 (e.g., viewing of data collected at the monitored system 560, processed by the service provider system 584, and transmitted back from the reporting web server 599 to the user interface 565). The user interface 565 typically includes a display 566 (such as a monitor) and one or more web browsers 567 to allow viewing of screens of collected and processed data including events, alarms, status, trends, and other information useful for monitoring and evaluating operation of the monitored system 560. The web browsers 567 provide the access point for users of the user interface 565.

Data providers 568 are included to collect operating and other data from the monitored portions of the system 560 and a data provider manager 564 is provided to control the data providers 568 and to transmit messages to the forwarding relay 520 including assigning a priority to each message. Preferably, the data providers 568 and data provider manager 564 and the relays 520, 518 consume minimal resources on the customer system 510. In one embodiment, the CPU utilization on the monitored system 560 is less than about 1 percent of the total CPU utilization and the CPU utilization on the relay system is less than about 5 percent of the total CPU utilization. The data provider manager 564 functions to coordinate collection of data by the data providers 568 and to broker the transmission of data with the relay 520.

The service provider system 584 is linked to the Internet 582 via the firewall 586 for communicating messages with the customer relay 518 and the forwarding relay 520. The service provider system 584 includes receivers 588 which are responsible for accepting data transmissions from the customer system 510 and brokering the data to the appropriate data loaders 594. Received messages or jobs are queued in job queue 592 and the job queue 592 holds the complete record of the data gathered by a provider 568 until it is processed by the data loaders 594. The job scheduler 590 is responsible for determining which jobs are run and in which order and enables loaders 594 to properly process incoming data. The data loaders 594 function to accept data from the receivers 588 and process the data into final format which is stored in storage 596 as monitored data 597 and asset data 598. The data loaders 594 are generally synchronized with the data providers 568 with, in some embodiments, a particular data loader 594 being matched to operate to load data from a particular data provider 568.

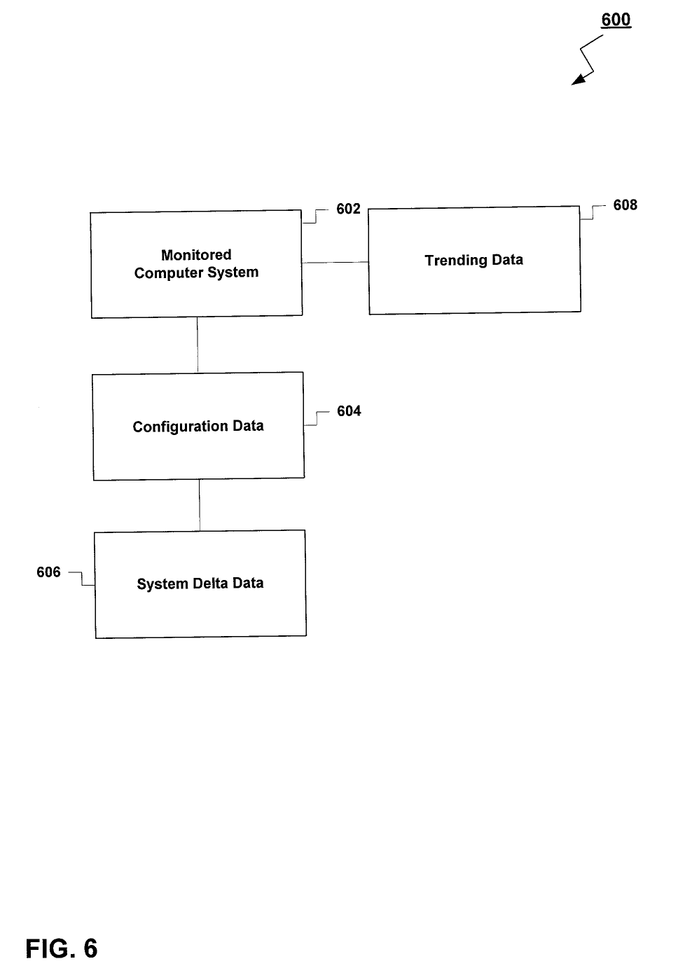

Turning now to FIG. 6, an example of a database of the present invention is shown that includes data structures for system delta reporting data. In this example database 600, a plurality of configuration data structures 604 are in the database 600, and each of the plurality of data structures 604 is associated with one or more data structures that identify a monitored computer system 602, also called a customer system, on the self-monitored network.

When a change is made to the hardware or software of a monitored computer system, at least one of the plurality of configuration data structures 604 stores the changed configuration information. A program that preferably runs on the remote service provider system notes when changes occur in the configuration data structures 604 and records a description of the change and the time the change occurred in the system delta data structure 606 of the database 600.

The system delta data structure 606 is also associated with at least one of a plurality of configuration data structures 604. These system delta data observations at different times can be considered as inputs to any binary operation, for example, (data (time 2)−data (time 1)) would represent a change in data between two observations and (data (time 2)−data (time 1))/(time 2−time 1) would represent the rate of change of data between the two observations. While only two binary operators have been presented in the example, others are possible. For example, a system delta reporting program preferably running on the service provider system may use system delta data stored in the database to report time correlations between configuration data and trending data on the self-monitored network. These reports can then be sent, preferably via the Internet, to a customer management node or some other system monitoring node. The reports can also preferably be incorporated into system alarm messages for alerting a system administrator when a configuration change adversely affects the performance of the self-monitored network.

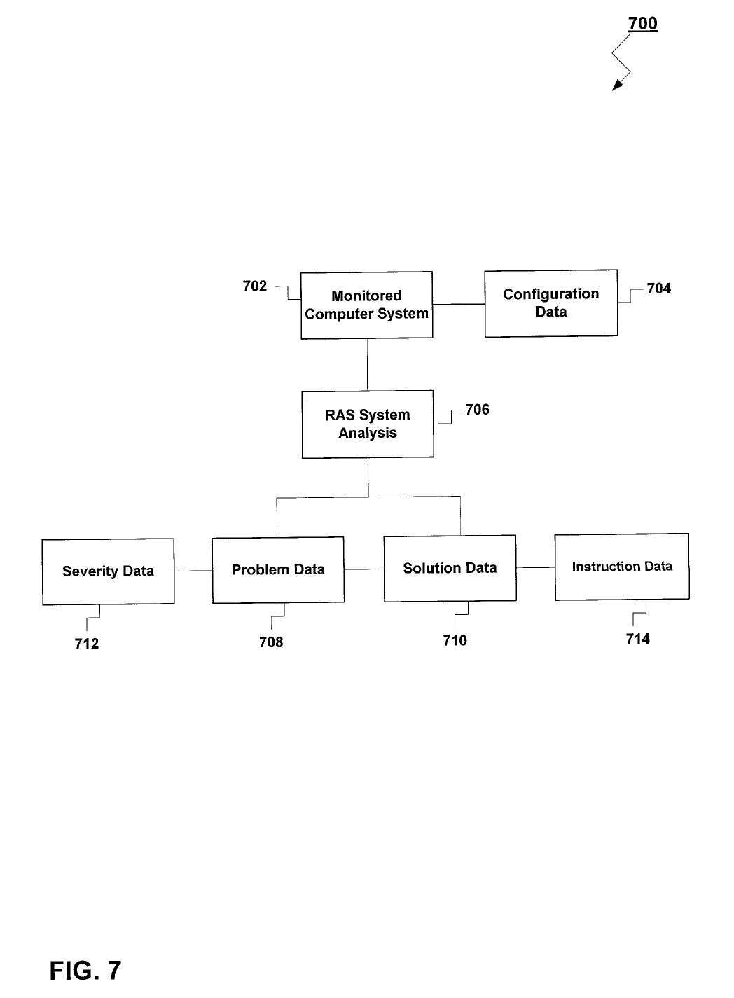

Turning now to FIG. 7, an example of a database 700 of the present invention is shown that includes an RAS system analysis data structure 706. RAS stands for Reliability Availability and Serviceability and an RAS system analysis is used to identify actual and potential trouble spots in the operation of the customer network. In this example database 700, a plurality of configuration data structures 704 are in the database 700, and each of the plurality of configuration data structures 704 is associated with one or more data structures that identify a monitored computer system 702 on the self-monitored network. In addition, at least one of the plurality of configuration data structures 704 is associated with the RAS system analysis data structure 706.

The RAS system analysis data structure 706 preferably comprises a problem data structure 708 and a solution data structure 710. The problem data structure 708 preferably includes information about an actual or potential problem in the self-monitored system based on information stored in one or more of the configuration data structures 704. The solution data structure 710 is associated with the problem data structure 708 and preferably includes information about solutions to the problem presented by the problem data structure 708.

The problem data structure 708 is preferably associated with a severity data structure 712 that provides information about the severity of the problem presented by the problem data structure 708. In a preferred aspect, the severity information is classified in one of a plurality of levels that range from the most critical to non-critical. In another preferred aspect, the severity information is classified in one of five levels ranging from most critical to non-critical.

The solution data structure 710 is preferably associated with one or more instruction data structures 714 that provide information for a system administrator on implementing the solution stored in the solution data structure 710. In another preferred aspect, the instruction data structure 714 is also associated with at least one of the plurality of configuration data structures 704 in order to select the most relevant instruction information in structure 714 based on the configuration of the monitored computer system 702 that will implement the solution.

One of ordinary skill in the art will recognize that the data structures shown in the database examples of FIGS. 6 and 7 are but one of many examples of database schema that can be implemented by the database of the present invention. In FIG. 7 for example, the problem data structure 708 and the severity data structure 712 could be integrated into a single data structure, as can the solution data structure 710 and the instruction data structure 714. In another alternative example, the problem data structure 708, solution data structure 710, severity data structure 712 and instruction data structure 714 may all be incorporated into the RAS system analysis data structure 706.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed.

We claim:

1. A database for a remote computer system monitoring service, the database comprising:
a plurality of configuration data structures, wherein each of said plurality of configuration data structures is associated with a monitored computer system, and wherein each of said configuration data structures comprises a searchable configuration attribute that includes information about the monitored computer system.

2. The database of claim 1, wherein said plurality of configuration data structures include hardware data structures, and software data structures.

3. The database of claim 1, wherein said database comprises a plurality of computer identity data structures, wherein each of the computer identity data structures are associated with a monitored computer system and with one or more of said configuration data structures,
and wherein each of said plurality of computer identity data structures comprises a searchable identity attribute of the monitored computer system.

4. The database of claim 3, wherein said searchable identity attribute is selected from the group consisting of customer system identifying data, relay identifying data, node identifying data, domain identifying data, operating system identifying data, client location data, client timezone data, security certificate data, alarm history data, reboot history data, threshold event history data, upgrade history data, start date data, and a unique identity number assigned by the self-monitoring system.

5. The database of claim 1, wherein said database comprises a plurality of trending data structures.

6. The database of claim 5, wherein said trending data structure includes trending data that is selected from the group consisting of storage system trends, file system trends, operating system trends, network trends, CPU trends, system memory trends, customer system trends, system rebooting trends, and rpc client trends and rpc server trends.

7. The database of claim 1, wherein said database is in electronic communication with a service provider system portion of the self-monitoring system.

8. A method of displaying a message from a self-monitoring system, comprising the steps of:
storing data from the self-monitoring system in a database;
processing the data from the database to generate the message; and
displaying the message at customer management node, wherein the database comprises an identity entity that uniquely identifies a customer system in electronic communication with the self-monitoring system; and
at least one data entity for data from the self-monitoring system.

9. The method of claim 8, wherein said data is selected from the group consisting of configuration data, and trending data.

10. The method of claim 8, wherein said message is an alarm.

11. The method of claim 8, wherein said message is a report.

12. The method of claim 8, wherein said customer management node comprises an internet browser.

13. The method of claim 8, wherein said identity entity comprises at least one attribute selected from the group consisting of customer system identifying data, relay identifying data, node identifying data, domain identifying data, operating system identifying data, client location data, client timezone data, security certificate data, alarm history data, reboot history data, threshold event history data, upgrade history data, start date data, and a unique identity number assigned by the self-monitoring system

14. The method of claim 8, wherein said data entity for data from the self-monitoring system is selected from the group consisting of a configuration data entity, a trending data entity, an alarm data entity, and a report data entity.

15. A self-monitoring system for providing self-service tools from a service provider system linked through a communications network to a customer network, comprising:
a communication pipeline within a customer network adapted for digital data transfer;
a plurality of monitored relays linked to the pipeline comprising end nodes running at least a portion of the provided self-service tools;
a forwarding relay linked to the pipeline upstream of the monitored relays adapted to control flow of data transmitted between the service provider system and the monitored relays, wherein the forwarding relay includes means for storing the transmitted data and selectively forwarding the stored data on the pipeline;
a customer relay linked to the pipeline and to the communications network providing a communication interface between the service provider system and the forwarding relay; and
a data structure stored in memory of the system including data resident in a database used by the service provider system in providing the self-service tool, wherein the data in the database includes data collected at the monitored relays and transmitted over the communication pipeline.

16. The self-monitoring system of claim 15, wherein said database is a relational database.

17. The self-monitoring system of claim 15, wherein said data comprises configuration data.

18. The self-monitoring system of claim 15, wherein said data comprises trending data.

19. The self-monitoring system of claim 15, wherein said communications network is the Internet.

20. The self-monitoring system of claim 15, wherein said self service tool comprises an Internet browser.

21. A database for a remote computer system monitoring service, the database comprising:
a plurality of configuration data structures, wherein each configuration data structure is associated with a particular monitored computer system; and
a system delta data structure, wherein the system delta data structure is associated with at least one of the plurality of configuration data structures, and includes information on a configuration change associated with said at least one configuration data structure.

22. The database of claim 21, wherein said information on the configuration change comprises a description of the configuration change, and a time the configuration change occurred.

23. The database of claim 21, wherein said database further comprises a plurality of trending data structures, wherein the system delta data structure is associated with at least one of the plurality of trending data structures.

24. A database for a remote computer system monitoring service, the database comprising:
a plurality of configuration data structures, wherein each configuration data structure is associated with a particular monitored computer system; and
a RAS system analysis data structure, wherein the RAS system analysis data structure is associated with at least one of the plurality of configuration data structures.

25. The database of claim 24, wherein said RAS system analysis data structure comprises:
a problem data structure, wherein the problem data structure is associated at least one configuration data structure from said plurality of configuration data structures, and includes problem information associated with said at least one configuration data structure; and
a solution data structure, wherein the solution data structure is associated with the problem data structure and includes solution information associated with the problem data structure.

26. The database of claim 25, wherein said RAS system analysis data structure comprises a severity data structure, wherein said severity data structure is associated with the problem data structure and includes a severity information associated with the problem data structure.

27. The database of claim 25, wherein said RAS system analysis data structure comprises an instruction data structure, wherein said instruction data structure is associated with the solution data structure and includes instructions for implementing the solution.
